(19) United States
(12) Patent Application Publication
(10) Pub. No.: US 2002/0147018 A1
(43) Pub. Date: Oct. 10, 2002

(54) Managing held RF channels in a wireless telephone system

(75) Inventors: Elie Jreij, Pflugerville, TX (US); James S. Umstetter, Taylor, TX (US); Long Nguyen, Pflugerville, TX (US)

Correspondence Address: Siemens Corporation, Attn: Elsa Keller, Legal Administrator, Intellectual Property Department, 186 Wood Avenue South, Iselin, NJ, 08830, US

(73) Assignee: SIEMENS INFORMATION AND COMMUNICATION PRODUCTS, LLC

(21) Appl. No.: 09/790,438

(22) Filed: Feb. 21, 2001

(51) Int. Cl. H04Q 7/20

(52) U.S. Cl. 455/452; 455/453; 455/464; 455/463

(57) ABSTRACT

An improved RF channel management scheme is described. In accordance with this scheme, decisions regarding whether to reserve or release a channel in a hold state are based upon system usage and configuration information. By this approach, the communication capacity of a wireless telephone system may be optimized for individual wireless communication environments. In one embodiment, whether an RF channel in a hold state is released or reserved is determined based, at least in part, upon a count of unused RF channels available to the wireless telephone system. In another embodiment, whether an RF channel in a hold state is released or reserved is determined based, at least in part, upon a class of service identifier assigned to a wireless telephone holding an RF channel in a hold state.

### TECHNICAL FIELD

This invention relates to systems and methods for extending the capacity of a wireless telephone system by managing held RF channels.

### BACKGROUND

Cordless telephone systems in the United States currently operate on separate radio frequency pairs (or channels) within relatively narrow frequency bands (e.g., 46-49 MHz, 902-928 MHz, and 2.4 GHz). A cordless telephone system typically includes a base station that is connected by a fixed wireline connection to a public switched telephone network (PSTN), and one or more cordless handsets that communicate with the base station over one of the available radio frequency (RF) channels. A user may make and receive telephone calls with a cordless handset anywhere within a limited distance (e.g., a few hundred feet) away from the base station. The actual range of operation depends upon a number of different factors, including the radiation power of the base station and the cordless handsets and the radio wave propagation characteristics of the geographic coverage area.

Wireless communication devices, such as cordless telephones, typically have a predetermined set of a limited number of RF channels on which communication signals may be transmitted and received. Before communication signals may be exchanged between a cordless telephone and a base station, a channel that is within the predetermined set, unoccupied by another device and free from interference must be assigned. Thus, as the number of communication devices being used in each wireless system increases, the number of RF channels available for any given call decreases.

A number of different systems have been proposed for increasing the channel usage capacity of a wireless communication system. For example, U.S. Pat. No. 4,876,708 describes a cordless telephone system in which a communication channel may be released while in a hold state to free the held channel for use by other cordless telephones. According to the '708 patent:

[W]hen the hold signal is received after a communication channel is established, the communication channel is set in a first hold state in which the radio channel is kept connected; within a first predetermined period of time after the first hold state is started, when the hold signal is received or no radio reception signal is detected, the communication channel is released, but when the on-hook signals is received, the communication channel is set in a second hold state in which the radio channel is disconnected; within a second predetermined period of time after the second hold state is started, when the off-hook signal is received, the communication channel is changed from the second hold state to the first hold state; and when a radio reception signal is not detected within the second predetermined period of time, the communication channel is forcibly disconnected and set in a stand-by state.

(Col. 2, lines 30-47). Thus, in accordance with the teachings of the '708 patent, decisions regarding whether to reserve or release a held channel are based simply upon the expiration of predetermined periods of time.

Still other systems for managing RF channels have been proposed.

### SUMMARY

The invention features an improved RF channel management scheme (systems and methods) in which decisions regarding whether to reserve or release a channel in a hold state are based upon system usage and configuration information. By this approach, the communication capacity of a wireless telephone system may be optimized for individual wireless communication environments.

In one aspect of the invention, whether an RF channel in a hold state is released or reserved is determined based, at least in part, upon a count of unused RF channels available to the wireless telephone system.

Embodiments in accordance with this aspect of the invention may include one or more of the following features.

Unused RF channels available to the wireless telephone system preferably are counted. The unused RF channels may be counted by scanning each RF channel available to the wireless telephone system.

In some embodiments, whether the RF channel in the hold state is released or reserved is determined by comparing the count of unused RF channels to a threshold number of unused RF channels. The RF channel in the hold state may be released in response to a determination that the count of unused RF channels is greater than or equal to a threshold number of unused RF channels. The RF channel in the hold state may be reserved in response to a determination that the count of unused RF channels is less than a threshold number of unused RF channels. The threshold number of unused RF channels may be set based upon a class of service identifier assigned to a wireless telephone holding the RF channel in the hold state.

In another aspect of the invention, whether an RF channel in a hold state is released or reserved is determined based, at least in part, upon a class of service identifier assigned to a wireless telephone holding an RF channel in a hold state.

Embodiments in accordance with this aspect of the invention may include one or more of the following features.

The channel in the hold state preferably is reserved in response to a determination that the assigned class of service identifier corresponds to a maximum class of service. The channel in the hold state may be released in response to a determination that the assigned class of service identifier corresponds to a minimum class of service. A threshold number of unused RF channels may be set based upon a class of service identifier assigned to a wireless telephone holding the RF channel in the hold state. Unused RF channels available to the wireless telephone system preferably are counted. The RF channel in the hold state may be released in response to a determination that a count of unused RF channels is greater than or equal to the threshold number of unused RF channels. The RF channel in the hold state may be reserved in response to a determination that a count of unused RF channels is less than the threshold number of unused RF channels.

A class of service identifier may be assigned to each wireless telephone in the wireless telephone system.

Other features and advantages of the invention will become apparent from the following description, including the drawings and the claims.

### DESCRIPTION OF DRAWINGS

FIG. 1 is a diagrammatic view of a cordless handset exchanging wireless telephone communication signals with a base station.

FIG. 2 is a block diagram of the cordless handset of FIG. 1.

FIG. 3 is a flow diagram of a method of managing RF channels in a wireless telephone system.

FIG. 4 is a flow diagram of an alternative method of managing RF channels in a wireless telephone system.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

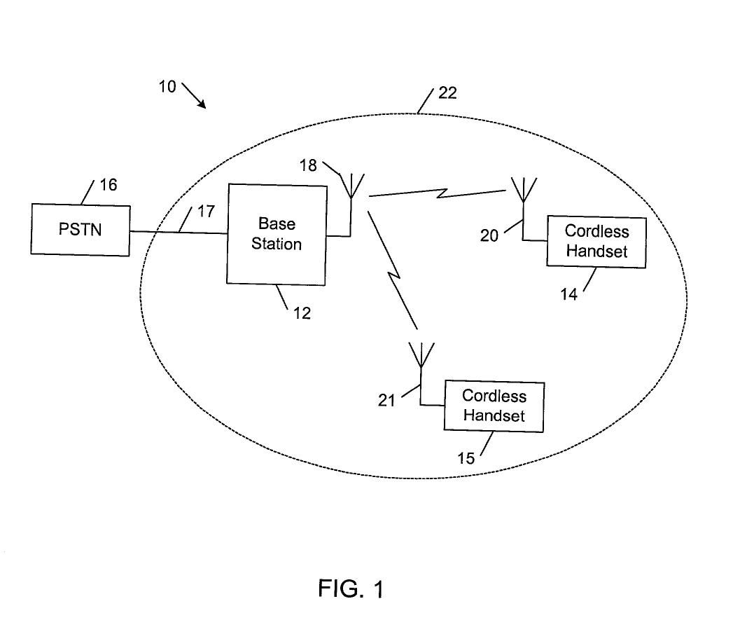

Referring to FIG. 1, in one embodiment, a cordless telephone system 10 includes a base station 12 and one or more cordless handsets 14, 15. Base station 12 is connected to a public switched telephone network (PSTN) 16 by a fixed wireline connection 17. Base station 12 communicates with cordless handsets 14, 15 over one or more radio frequency (RF) communication channels. The RF communication channels may lie within the 46-49 MHz frequency band, the 902-928 MHz frequency band, or the 2.4 GHz frequency band. Base station 12 and cordless handsets 14, 15 include respective antennas 18, 20, 21 for exchanging RF communication signals. Base station 12 communicates with cordless handsets 14, 15 over a control channel in order to designate one or more voice channels over which wireless communication signals may be exchanged between base station 12 and cordless handsets 14, 15. Base station 12 preferably determines which RF channels are both authorized for cordless operation and available (i.e., meets certain prescribed minimum channel quality criteria, e.g., freedom from interference for a prescribed period of time). In operation, base station 12 modulates telephone communication signals received from PSTN 16 onto a radio carrier for transmission to cordless handsets 14, 15. Base station 12 also demodulates RF telephone communication signals received from cordless handsets 14, 15 into electrical signals for transmission to PSTN 16 over fixed wireline connection 17. A user of one of cordless handsets 14, 15 may make and receive telephone calls anywhere within a limited geographic coverage area 22 surrounding base station 12. The geographic coverage area 22 typically may extend only a few hundred feet away from base station 12.

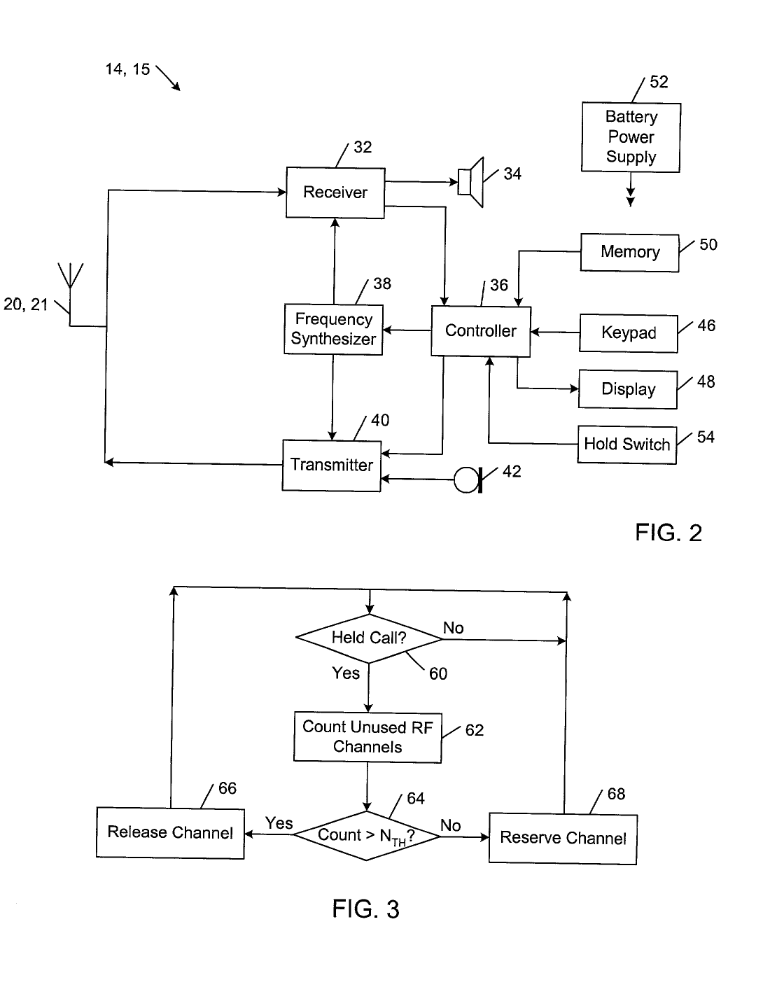

Referring to FIG. 2, cordless handsets 14, 15 each includes a receiver 32, a speaker 34, a controller 36, a frequency synthesizer 38, a transmitter 40, a microphone 42, a keypad 46, a display 48, a memory 50, and a battery power supply 52. In addition, cordless handsets 14, 15 each includes a hold mode selection switch 54 that enables a user to selectively place a call on hold or retrieve a call from a hold state. Controller 36 choreographs the operation of receiver 32, transmitter 40 and frequency synthesizer 38. Frequency synthesizer 38 controls the operating frequencies of receiver 32 and transmitter 40, and generates electronic ring signals in response to control signals received from controller 36.

In operation, cordless handsets 14, 15 operate as conventional cordless telephone handsets. Thus, telephone calls may be placed and received through cordless handsets 14, 15, each of which communicates with base station 12 over one or more of the available voice channels. Base station 12 operates to exchange voice signals between PSTN 16 and cordless handsets 14, 15. In particular, when a call initially is received from PSTN 16, base station 12 transmits a ring signal to cordless handsets 14, 15 over an RF control channel. In response, speaker 34 generates an audible ring signal from an electronic ring signal received from frequency synthesizer 38. After the user takes one of cordless handsets 14, 15 off hook, base station 12 transmits a voice signal from PSTN 16 to cordless handset 14 over an available voice channel. Antenna 20 converts the RF communication signals received from base station 12 into electrical signals. Receiver 32 filters and demodulates the electrical signals to produce electrical voice signals. Speaker 34 generates from the electrical voice signals an audible voice message for the user of the active cordless handset. Microphone 42 converts responsive audible voice messages received from the user of the active cordless handset into an electrical voice signals. Transmitter 40 modulates the electrical voice signals onto a radio carrier supplied by frequency synthesizer 38. Antenna 20 transmits the modulated radio carrier with the responsive voice message to base station 12.

Wireless communication signals may be transmitted between base station 12 and cordless handsets 14, 15 in accordance with conventional channel selection, signal coding and other cordless telephone transmission protocols.

As mentioned above, cordless telephone system 10 features an improved RF channel management scheme in which decisions regarding whether to reserve or release a channel in a hold state are based upon system usage and configuration information. By this approach, the communication capacity of wireless telephone system 10 may be optimized for individual wireless communication environments.

Referring to FIG. 3, in one embodiment, base station 12 may be configured to manage RF channels during a held call as follows. In response to a hold mode selection signal received from a cordless handset 14, 15 (step 60), bases station 12 determines the number of unused RF channels that are available to cordless telephone system 10 (step 62). The number of unused channels may be determined by scanning the channels assigned to cordless telephone system 10 and counting the number of channels that are available (i.e., both unoccupied by another device and free from interference). If the count of unused RF channels is greater than a threshold number of unused channels (N_{TH}) (step 64), the channel in the hold state is released into the idle RF channel pool (step 66). Otherwise, the channel in the hold state is reserved for the held call (step 68). The threshold number of unused channels (N_{TH}) preferably is selected so that there is a relatively high probability that there will be a sufficient number of RF channels on hand for a held call whose channel has been released into the idle RF channel pool to be re-established with an RF channel assigned from the idle RF channel pool. The threshold number of unused channels (N_{TH}) may be determined statistically.

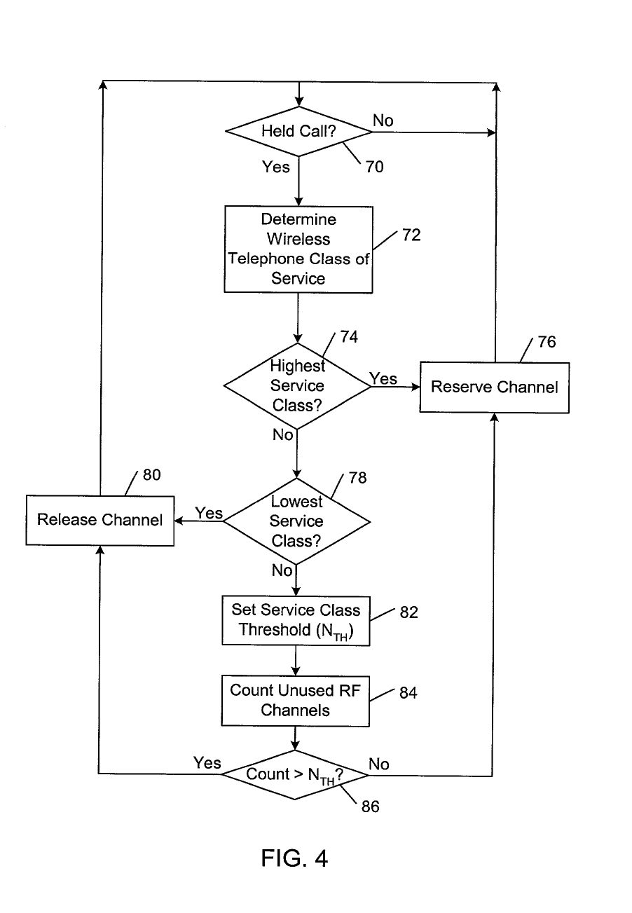

Referring to FIG. 4, in another embodiment, base station 12 may be configured to manage RF channels during a held call based, at least in part, upon a class of service identifier assigned to the cordless handset holding the call as follows. In response to a hold mode selection signal received from a cordless handset 14, 15 (step 70), base station 12 determines the class of service that is assigned to the cordless telephone holding the RF channel in the hold state (step 72). The class of service may be determine based upon a class of service identifier that is assigned to each cordless handset 14, 15 in cordless telephone system 10. The class of service identifier may be assigned by base station 12 or it may be set by each cordless handset 14, 15. If the class of service corresponds to a maximum class of service (step 74), the channel in the hold state is reserved (step 76). If the class of service corresponds to a minimum class of service (step 78), the channel in the hold state is released into the idle RF channel pool (step 80). If the class of service does not correspond to a maximum service class nor a minimum service class, base station 12 sets a service class threshold (N_{TH}) based upon the service class identifier (step 82). For example, in one embodiment, there may be five service classes with service class 5 corresponding to a maximum service class and service class 1 corresponding to a minimum service class. The service class threshold (N_{TH}) may be set for service classes 4-2 as show in Table 1, below:

TABLE 1

| | SERVICE CLASS THRESHOLD |
|---|---|
| SERVICE CLASS | (N_{TH}) |
| 2 | 2 |
| 3 | 3 |
| 4 | 4 |

Bases station 12 then determines the number of unused RF channels that are available to cordless telephone system 10 (step 84). The number of unused channels may be determined by scanning the channels assigned to cordless telephone system 10 and counting the number of channels that are available (i.e., both unoccupied by another device and free from interference). If the count of unused RF channels is greater than a threshold number of unused channels (N_{TH}) (step 86), the channel in the hold state is released into the idle RF channel pool (step 80). Otherwise, the channel in the hold state is reserved for the held call (step 76).

Other embodiments are within the scope of the claims. For example, although the above embodiments are described in connection with a cordless telephone system, they also may be implemented in any wireless communication device system, including communication systems for portable cellular radiophones, pagers, electronic organizers, and computers.

Still other embodiments are within the scope of the claims.

What is claimed is:

1. A method of managing radio frequency (RF) channels in a wireless telephone system, comprising:
determining whether to release or reserve an RF channel in a hold state based, at least in part, upon a count of unused RF channels available to the wireless telephone system.

2. The method of claim 1, further comprising counting unused RF channels available to the wireless telephone system.

3. The method of claim 2, wherein unused RF channels are counted by scanning each RF channel available to the wireless telephone system.

4. The method of claim 1, wherein determining whether to release or reserve the channel in the hold state comprises comparing the count of unused RF channels to a threshold number of unused RF channels.

5. The method of claim 4, wherein the RF channel in the hold state is released in response to a determination that the count of unused RF channels is greater than or equal to a threshold number of unused RF channels.

6. The method of claim 4, wherein the RF channel in the hold state is reserved in response to a determination that the count of unused RF channels is less than a threshold number of unused RF channels.

7. The method of claim 4, further comprising set ting the threshold number of unused RF channels based upon a class of service identifier assigned to a wireless telephone holding the RF channel in the hold state.

8. A method of managing radio frequency (RF) channels in a wireless telephone system, comprising:
determining whether to release or reserve an RF channel in a hold state based, at least in part, upon a class of service identifier assigned to a wireless telephone holding an RF channel in a hold state.

9. The method of claim 8, wherein the channel in the hold state is reserved in response to a determination that the assigned class of service identifier corresponds to a maximum class of service.

10. The method of claim 8, wherein the channel in the hold state is released in response to a determination that the assigned class of service identifier corresponds to a minimum class of service.

11. The method of claim 8, further comprising setting a threshold number of unused RF channels based upon a class of service identifier assigned to a wireless telephone holding the RF channel in the hold state.

12. The method of claim 11, further comprising counting unused RF channels available to the wireless telephone system.

13. The method of claim 12, wherein the RF channel in the hold state is released in response to a determination that a count of unused RF channels is greater than or equal to the threshold number of unused RF channels.

14. The method of claim 12, wherein the RF channel in the hold state is reserved in response to a determination that a count of unused RF channels is less than the threshold number of unused RF channels.

15. The method of claim 8, further comprising assigning a class of service identifier to each wireless telephone in the wireless telephone system.

16. A wireless telephone system, comprising:
a base station configured to determine whether to release or reserve an RF channel in a hold state based, at least in part, upon a count of unused RF channels available to the wireless telephone system.

17. The system of claim 16, wherein the wherein the base station is configured to determine whether to release or reserve the channel in the hold state by comparing the count of unused RF channels to a threshold number of unused RF channels.

18. The system of claim 17, wherein the RF channel in the hold state is released in response to a determination that the count of unused RF channels is greater than or equal to a threshold number of unused RF channels.

19. A wireless telephone system, comprising:
a base station configured to determine whether to release or reserve an RF channel in a hold state based, at least in part, upon a class of service identifier assigned to a wireless telephone holding an RF channel in a hold state.

20. The system of claim 19, further comprising setting a threshold number of unused RF channels based upon a class of service identifier assigned to a wireless telephone holding the RF channel in the hold state.
